(19) United States
(12) Patent Application Publication
(10) Pub. No.: US 2016/0237952 A1
(43) Pub. Date: Aug. 18, 2016

(54) AUTOGENOUS PRESSURIZER DEVICE FOR A PROPELLANT TANK

(71) Applicant: SNECMA, Paris (FR)

(72) Inventors: Antoine CARATGE, Marnes La Coquette (FR); Jean Michel SANNINO, Saint-Marcel (FR); Stephanie DREYER, Vernon (FR); Jean-Luc BARTHOULOT, Panilleuse (FR)

(73) Assignee: SNECMA, Paris (FR)

(21) Appl. No.: 15/031,484

(22) PCT Filed: Oct. 21, 2014
(86) PCT No.: PCT/FR2014/052665

§ 371 Date: Apr. 22, 2016

(30) Foreign Application Priority Data
Oct. 24, 2013 (FR) 1360363

(51) Int. Cl. F02K 9/58; F02K 9/60; F02K 9/42

(52) U.S. Cl. CPC F02K 9/58; F02K 9/425; F02K 9/605; F05D 2220/80

(57) ABSTRACT

An autogenous pressurizer device for a main propellant tank, the device includes a pressurizer pipe connected to the main tank to inject propellant into the main tank, a pressurizer valve arranged on the pressurizer pipe, and a heater for heating the propellant upstream from the pressurizer valve. The pressurizer device includes a buffer tank connected to the pressurizer pipe upstream from the pressurizer valve.

### FIELD OF THE INVENTION

The present description relates to a pressurizer device, and more particularly to an autogenous pressurizer device for a main propellant tank, e.g. for a rocket engine.

### BACKGROUND

In vehicles propelled by reaction engines, in particular rocket engines, the propellant tanks need to be pressurized when starting the rocket engines, and also continuously during operation of the rocket engines. The pressure at the inlet of each engine needs to be maintained for reasons of operability, and it is found to be necessary for the volume of propellant that has been sucked out to be replaced with a gas at the right pressure. This gas is supplied by a pressurizer system of the tank.

More particularly, for cryogenic rocket engines fed with cryogenic propellants, such as liquid oxygen and hydrogen for example, the tanks of the cryogenic propellants can be de-pressurized during ballistic stages of flight, in order to cool propellants that have previously been heated (by the action of the sun, or by heat conduction coming from an adjacent tank that is at higher temperature). For that purpose, the tank pressure is set to a value that is a little lower than the saturation pressure of the propellant in question. The propellant starts to boil, and the energy needed for vaporizing the propellant is taken from the mass of liquid propellant, which therefore cools. In order subsequently to be able to ignite the engine, it is necessary to re-pressurize such propellant tanks that have previously been de-pressurized.

Commonly used re-pressurizer systems make use of a re-pressurizing gas, such as helium, that is stored in gaseous form at high pressure. Nevertheless, given the problems associated with storing a gas under pressure and with the increase of on-board weight, manufacturers have developed so-called “autogenous” pressurizer systems in which the fluid used for pressurizing a tank is the same as the propellant stored in that tank, but in the gaseous state.

By way of example, French patent application FR 2 975 441 A1 discloses an autogenous pressurizer device for a main propellant tank, the device comprising a pressurizer pipe connected to the main tank to inject the propellant into said main tank, and a heater for heating the propellant. Such a device may include a pressurizer valve arranged in the pressurizer pipe, in which case the heater is placed so as to heat the propellant upstream from the pressurizer valve. Thus, the pressure of the propellant increases on passing through the heater and the heated propellant can be used for re-pressurizing the main tank.

Nevertheless, such a device requires the pressurizer valve to be continuously regulated in order to control the pressure in the main tank. Furthermore, the main tank is pressurized progressively as the propellant flows through the heater, and that can be found to be too slow.

### SUMMARY OF THE INVENTION

The object of the present invention is to remedy the above-mentioned drawbacks, at least substantially.

This object is achieved by the fact that the pressurizer device comprises a buffer tank connected to the pressurizer pipe upstream from the pressurizer valve.

Thus, the propellant contained in the buffer tank forms a source of pressurizing fluid that is available at any time for pressurizing the main tank. Furthermore, the buffer tank performs a regulation function for controlling the pressure in the main tank. Thus, there is no need for the autogenous pressurizer system to be fed continuously.

In the present disclosure, and unless specified to the contrary, the terms “upstream” and “downstream” are used relative to the normal flow direction of the propellant, in particular from the buffer tank to the main tank, when referring to the pressurizing propellant.

Furthermore, in the present disclosure, the liquid and gaseous states should be understood broadly so as to encompass the supercritical state. By extension, a fluid in the supercritical state is said to be “liquid” if it is relatively dense, and it is said to be “gaseous” if its density is relatively low. Likewise, the terms “vaporized” and “condensed” may be applied to a supercritical fluid respectively to refer to a reduction and to an increase in its density, even if there is no proper change of state. Finally, “vaporized” and “condensed” may refer to passing from the liquid to the gaseous states proper and vice versa by passing through the supercritical state.

In certain embodiments, the heater is installed so as to heat the propellant contained in the buffer tank. In this way, heating is performed effectively for a volume having small specific area. Furthermore, handling tanks under pressure is dangerous, in particular while performing operating activities on the launcher on the ground; in such embodiments, there is no need to fill the buffer tank with gaseous propellant from the beginning since it is possible to heat and vaporize the propellant contained in the buffer tank once said buffer tank has been installed and partially filled with liquid propellant.

In certain embodiments, the pressurizer device comprises a first feed pipe connecting the main tank to the buffer tank and suitable for feeding the buffer tank with propellant coming from the main tank. The buffer tank can thus be fed with liquid propellant coming from the main tank.

Alternatively, or in combination, in certain embodiments, the pressurizer device comprises a second feed pipe connected to the buffer tank and capable of being connected to a propellant feed circuit of a rocket engine in order to feed the buffer tank with propellant coming from said feed circuit. Advantageously, said propellant coming from the feed circuit is the propellant under pressure.

The propellant feed circuit of the rocket engine may comprise a regenerator circuit serving to cool the combustion chamber and thereby serving as a heat source necessary for operating turbines and as a source of gaseous propellant. In such embodiments, the rocket engine may make use of the second feed pipe to supply the buffer tank with propellant that is heated or vaporized, e.g. by the regenerator circuit. Filling the buffer tank with propellant at a higher temperature makes it possible to save energy by using the heater less.

In certain embodiments, the pressurizer device comprises an exhaust pipe connected to the buffer tank and provided with a regulator device for regulating the pressure in the buffer tank.

The pressure regulator device may be a controlled valve, a calibrated valve, or any equivalent device that the person skilled in the art finds compatible. The exhaust pipe and the pressure regulator device thus make it possible to ensure that the pressure in the buffer tank does not exceed a design pressure beyond which there might be a failure of the mechanical strength of the buffer tank or of the pressurizer pipe, or indeed of the operability of the pressurizer valve, for example.

In certain embodiments, the heater is electric. It may be an electrical resistance. The heater is thus particularly simple in its design and its operation. It can also be controlled accurately. Compared with a heat exchanger, an electric heater has the advantage of not taking heat from any other portion of the pressurizer device, in particular from lines for feeding turbines of the engine. Under such circumstances, open or closed expander cycle engines (where such cycles are known to the person skilled in the art as “bleed” or “expander”), the temperatures of the propellants at the inlets of the turbines constitute parameters of major importance for reasons of engine operability; it is therefore appropriate to avoid using these propellants as sources of heat. The use of an electric heater therefore does not disturb the design dimensions and the operating parameters of existing systems.

In certain embodiments, the pressurizer device comprises a fuel cell electrically connected to the heater for supplying electricity to the heater. A fuel cell forms an electricity supply that is simple and reliable. In addition, it enables optimum use to be made of the resources available in the pressurizer device.

In certain embodiments, an auxiliary pipe extends between the buffer tank and the fuel cell in order to fill the fuel cell with propellant. In such embodiments, the fuel cell is connected indirectly to the main tank via the buffer tank. It is thus in fact fed with propellant coming from the buffer tank, which propellant may be in gaseous form. The buffer tank can thus be used also to regulate the propellant fed to the fuel cell.

The present description also relates to a rocket engine feed device comprising a first main tank suitable for containing a first propellant, a first pressurizer device for pressurizing the first main tank, a second main tank suitable for containing a second propellant, and a second pressurizer device for pressurizing the second main tank, wherein the fuel cell is configured to produce electricity from a reaction between the first propellant and the second propellant.

Such a feed device presents autogenous pressurization for each main tank. A single fuel cell fed with the first propellant and with the second propellant serves to supply electricity to the electric heater in each autogenous pressurizer device. Such a feed device is thus particularly compact and does not require any other feed or pressurizing fluid other than the propellant contained in the main tank.

The present description also relates to a pressurizing method for pressurizing a main propellant tank, the method being characterized in that it comprises:

filling a buffer tank with propellant from the main tank;

using a heater to heat the pressurizing fluid situated upstream from a pressurizer valve, the pressurizer valve being arranged in a pressurizer pipe connecting the buffer tank to the main tank; and

opening the pressurizer valve to enable the heated propellant to flow to the main tank.

By means of such a method, the main tank can be pressurized in autogenous manner without providing a complex regulator system since regulation takes place via the buffer tank. Furthermore, because the propellant is heated (or indeed vaporized) in situ, there is no need to handle a tank under pressure while preparing the launcher on the ground, thereby significantly reducing any risk of explosion while installing the tanks or the launcher stage, thereby greatly facilitating operating activities, in particular on the ground, as performed by ground crew. The buffer tank can be filled with liquid propellant coming from the main tank. This filling takes place merely under gravity (in particular when the stage having the main tank is on the ground).

In certain embodiments, the pressuring method comprises, before the step of filling the buffer tank, filling the main tank with propellant in the liquid state from an external propellant feed.

### BRIEF DESCRIPTION OF THE DRAWINGS

The invention and its advantages can be better understood on reading the following detailed description of embodiments of the invention given as non-limiting examples. The description refers to the accompanying drawings, in which:

FIG. 1 shows a propellant feed device for a rocket engine; and

FIGS. 2A and 2B show respective possible types of constriction for use in the FIG. 1 feed device.

### DETAILED DESCRIPTION OF THE INVENTION

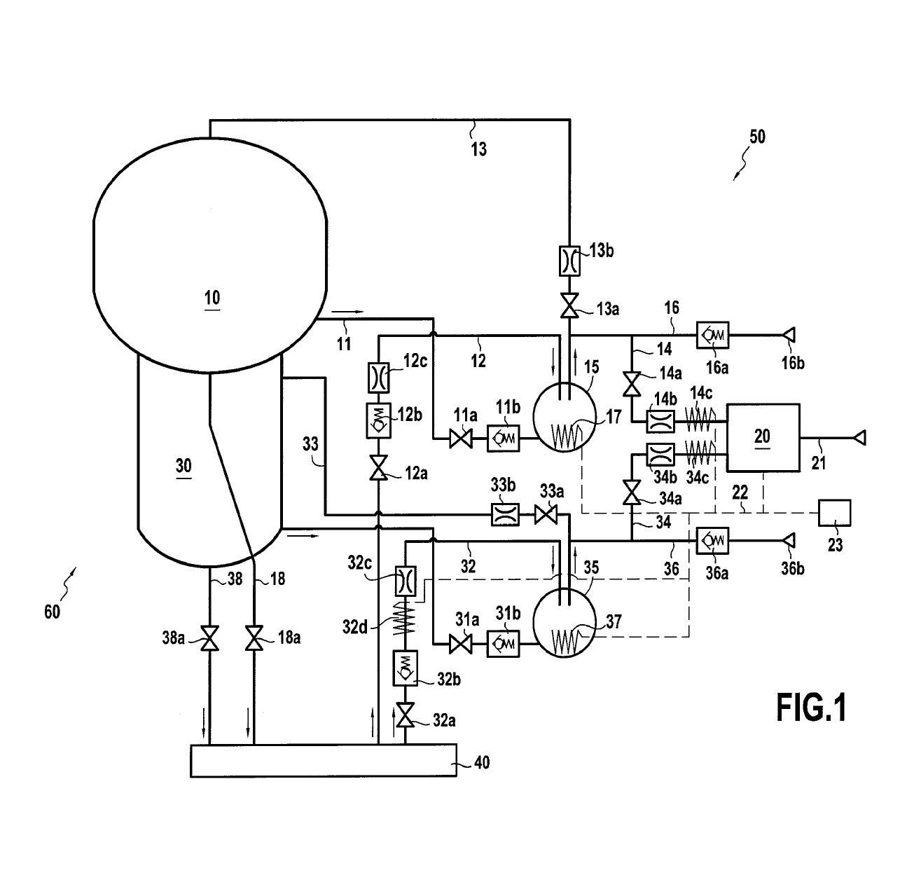

A feed device 60 for a rocket engine 40 is shown in FIG. 1. The feed device 60 has a first tank 10 suitable for containing a first propellant, e.g. liquid hydrogen, a first pressurizer device for pressurizing the first main tank 10, a second main tank 30 suitable for containing a second propellant, e.g. liquid oxygen, and a second pressurizer device for pressurizing the second main tank 30. The rocket engine 40 is fed with first propellant via a first pipe 18 having first valve 18a, and with second propellant via a second pipe 38 having a second valve 38a. The pipes 18 and 38 are connected within the rocket engine 40 to a feed circuit (not shown) that may include other pipes, pumps, other valves, etc.

The composition of the rocket engine 40 is conventional and well known to the person skilled in the art. In particular, in the context of the present invention, it may be an engine having a cycle without a gas generator, e.g. an engine of the “expander” or “bleed” cycle type. If the heat sources of such an engine are used by a pressurizer system, that can significantly affect the performance of the engine.

Each main tank 10, 30 has a pressurizer device. In the present embodiment, the two pressurizer devices are very similar, which is why only the pressurizer device 50 for the first main tank 10 is described. Unless specified to the contrary, all of the explanations concerning elements of the pressurizer device for the first main tank 10 can be applied likewise to the corresponding elements relating to the pressurizer device of the second main tank 30. Variants may naturally be provided depending on the objectives of the person skilled in the art.

The pressurizer device 50 comprises a buffer tank 15 and a propellant pipe 13 connecting the buffer tank 15 to the main tank 10 in order to inject propellant into said main tank 10. The pressurizer pipe 13 is provided with a pressurizer valve 13a and with a constriction 13b for controlling the flow of pressurizer propellant. An electric heater 17 heats the propellant contained in the buffer tank 15. The electric heater 17 may be placed inside the buffer tank 15 or at its periphery. Because of the heater 17, the propellant injected by the pressurizer pipe 13 into the main tank 10 is in gaseous form.

The buffer tank 15 may be large enough to enable the main tank 10 to be completely repressurized after a period of ballistic flight preceding reignition of the rocket engine 40.

The pressurizer device 50 also has a first feed pipe 11 connecting the main tank 10 to the buffer tank 15 and suitable for feeding the buffer tank 15 with propellant coming from the main tank 10. The first feed pipe 11 has a valve 11a and a check valve 11b for ensuring that propellant flows in one direction from the main tank 10 to the buffer tank 15. Said propellant coming from the main tank 10 is generally liquid propellant.

The pressurizer device 50 also has a second feed pipe 12 connected to the buffer tank 15 and suitable for connecting to the feed circuit (not shown) of the rocket engine 40 in order to feed the buffer tank 15 with propellant coming from said feed circuit. In particular, when the feed circuit comprises a regenerative circuit, or more generally a circuit for recovering heat given off by the combustion chamber, the propellant sent from the rocket engine to the second feed pipe 12 may be propellant that is heated, and possibly vaporized. Thus, whereas the first feed pipe 11 serves to fill the buffer tank 15 with liquid propellant, the second feed pipe 12 serves to fill the buffer tank 15 with propellant at higher temperature, that might be vaporized. Energy savings for the heater 17 are thus possible.

The second feed pipe 12 has a valve 12a, a check valve 12b, and a constriction 12c for controlling the flow rate of gaseous propellant feeding the buffer tank 15. Conversely, the first feed pipe 11 does not require a constriction because the flow rate of liquid propellant is low since typically it passes through a pipe of small diameter.

In the embodiment shown in FIG. 1, the propellant entering into the second pressurizer pipe 12 is hot enough to go to the buffer tank 15. For example, it may be hydrogen that has been used to cool the combustion chamber, and that is thus in the gaseous state. Conversely, oxygen is supplied to the second feed pipe 32 in the liquid state since as a general rule there is no hot oxygen present in the rocket engine for thermodynamic and safety reasons. In order to heat the liquid oxygen prior to introducing it into the oxygen buffer tank 35, a heater 32d is provided for the oxygen second feed pipe 32, e.g. between the check valve 32b and the constriction 32c. Specifically, the heater 32d is an electric heater.

In order to regulate pressure in the buffer tank 15, an exhaust pipe 16 is connected to the buffer tank 15 and provided with a pressure regulator device comprising a calibrated valve 16a and an ejection coupling 16b. The ejection coupling 16b may lead to the open air (in particular for oxygen), or to a purge line (in particular for hydrogen). The calibrated valve 16a is configured to open when the pressure difference across its ends exceeds a certain threshold. This makes it possible to limit the pressure in the buffer tank 15 and in the pipe connected to the buffer tank 15 upstream and/or downstream from said buffer tank 15. The exhaust pipe 16 serves to discharge all surplus propellant supplied by the first feed pipe 11 and/or by the second feed pipe 12.

Furthermore, the feed device 50 includes a fuel cell 20. An auxiliary pipe 14 extends between the buffer tank 15 and the fuel cell 20 in order to feed the fuel cell 20 with gaseous propellant. The auxiliary pipe 14 has a valve 14a, a constriction 14b, and a heater 14c. The heater 14c is optional and serves to increase the temperature of the propellant before it enters the fuel cell 20 if it has not already been heated sufficiently by the heater 17 or if the optimum operating temperature of the fuel cell 20 is higher than the optimum temperature for propellant as a fluid for pressurizing the main tank 10.

A similar structure is provided for the pressurizer device of the main tank 30, so the fuel cell 20 is fed with two propellants by the first and second auxiliary pipes 14, 34. The reaction between these two propellants serves to produce electricity. The fuel cell 20 can thus feed electricity to some or all of the heaters 17, 37, 14c, 34c, 32d, as appropriate, via an electrical circuit 22. The electrical circuit 22 may present a connector for connecting to an external electricity source 23, e.g. a battery or an external network.

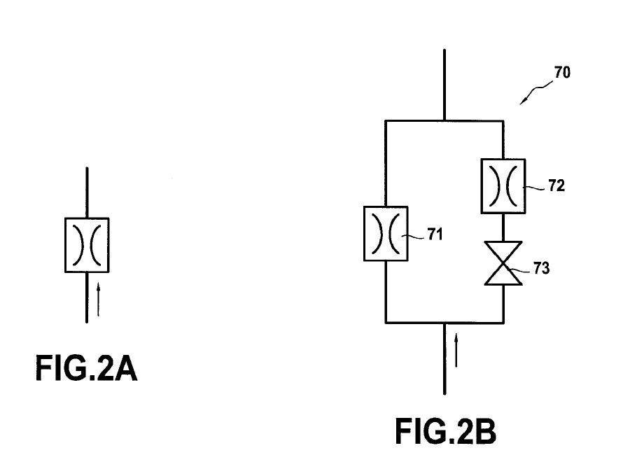

Furthermore, in spite of being shown diagrammatically in FIG. 1, the constrictions 12c, 13b, 14b, 32c, 33b, and/or 34b may be of any type and in particular they may be simple constrictions as shown in FIG. 2A, or they may be adjustable constrictions that may be referred to as “all-or-little” constrictions. FIG. 2B shows an all-or-little constriction 70. It has two simple constrictions 71 and 72 connected in parallel, with one of the two constrictions (specifically the constriction 72) being preceded in its own branch by a valve 73. In practice, the flow rate through the constriction 72 may be two to three times greater than the flow rate through the constriction 71. Thus, when the valve 73 is closed, a small flow rate passes through the constriction 70, whereas when the valve 73 is open, the flow rate passing through the constriction 70 is much greater. Settings for an all-or-little constriction come within the competence of the person skilled in the art.

A method of pressurizing the main tank 10 may take place as follows. In an initial state, the valves 11a, 12a, 13a, 14a, and 18a are closed. To begin with, on the ground or prior to takeoff of the rocket engine, the main tank 10 is filled with propellant in the liquid state from an external propellant feed (not shown). The valve 11a is opened so that the buffer tank 15 becomes partially filled with liquid propellant from the main tank 10 as soon as the hydrostatic pressure upstream from the check valve 11b is greater than the threshold for opening the valve 11b. The valve 13a is also open during this period so that gas present in the buffer tank can escape. The filling of the buffer tank 15 stops when a predefined level is reached. Thereafter, once the valves 11a and 13a have been closed as a result of stopping the filling of the buffer tank 15, the external electricity source 23 supplies the heater 17 with the energy needed for heating and vaporizing the propellant contained in the buffer tank. In usual configurations, the propellant immediately begins to boil (since in the main tank, its temperature is generally equal to the saturation temperature of the propellant at a pressure of 1 bar). Thus, pressure rises in the buffer tank. In the event of pressure rising too much, a fraction of the vaporized propellant is discharged via the exhaust pipe 16. The heating stage terminates when the propellant reaches a predefined temperature or pressure criterion. The valve 14a is then opened in order to feed the fuel cell 20 with said propellant.

Similar operations may be performed for the second propellant, the second main tank 30, and the second buffer tank 35. The fuel cell 20 is thus fed with two propellants, which, on reacting, produce electricity that can be used for the heaters 17 and 37. From this stage, the external electricity source 23 is no longer necessary for the autogenous pressurizer device 50.

Thereafter, the valve 13a can be opened to perform autogenous pressurizing of the main tank 10 up to the pressure needed for starting the engine. Once this target pressure is reached (which is almost instantaneous under ordinary conditions), the rocket engine 40 can be started; the valve 18a is then opened in order to feed propellant from the main tank 10.

The operation of the rocket engine 40 enables the buffer tank 15 to be fed with heated propellant coming from the rocket engine 40 via the second feed pipe 12. It is thus possible to open the valve 12a. The main tank 10 is thus pressurized by a controlled transfer of propellant from the rocket engine 40 to the main tank 10 via the buffer tank 15 where it may possibly be heated once more.

When the rocket engine 40 is shut down, the buffer tank 15 is full. It is of sufficient volume to re-pressurize the main tank 10 prior to any restart of the rocket engine 40. During ballistic flight, the buffer tank 15 may be heated because it is exposed to the sun, and the pressure of the gaseous propellant may increase. If the pressure becomes excessive, a fraction of the propellant is discharged via the exhaust pipe 16.

Such a pressurizing method is particularly advantageous insofar as no provision is made for manipulating filled and pressurized buffer tanks on the ground, and insofar as there is no need to bring gas under high pressure to the launch pad in order to feed said buffer tank 15, 35, directly.

In addition, although the production of as in the buffer tank 15, 35 is described as taking place on the ground prior to launch, it can also take place at other instants, e.g. during flight while being propelled by lower stages. Furthermore, it can clearly be seen from the present description as a whole that the autogenous pressurizer device 50 is capable, on its own, of pressurizing the main tank 10 not only prior to starting the rocket engine 40, but also while said rocket engine 40 is in operation and prior to restarting the rocket engine 40, e.g. at the end of a ballistic stage. In other words, the autogenous pressurizer device 50 is capable of providing all of the pressurization needs of the rocket engine feed device 60.

Although the present invention is described with reference to specific embodiments, modifications may be made thereto without going beyond the general ambit of the invention as defined by the claims. In particular, the individual characteristics of the various embodiments shown and/or mentioned may be combined in additional embodiments. Consequently, the description and the drawings should be considered in a sense that is illustrative rather than restrictive.

1. An autogenous pressurizer device for a main propellant tank, the device comprising a pressurizer pipe connected to the main tank to inject propellant into said main tank, a pressurizer valve arranged on the pressurizer pipe, and a heater for heating the propellant upstream from the pressurizer valve, wherein the pressurizer device comprises a buffer tank connected to the pressurizer pipe upstream from the pressurizer valve, the heater is electric,
the device further includes a fuel cell electrically connected to the heater for supplying electricity to the heater, and in that an auxiliary pipe extends between the buffer tank and the fuel cell in order to fill the fuel cell with propellant.

2. The pressurizer device according to claim 1, the heater being installed so as to heat the propellant contained in the buffer tank.

3. The pressurizer device according to claim 1, including a first feed pipe connecting the main tank to the buffer tank and suitable for feeding the buffer tank with propellant coming from the main tank.

4. The pressurizer device according to any claim 1, including a second feed pipe connected to the buffer tank and capable of being connected to a propellant feed circuit of a rocket engine in order to feed the buffer tank with propellant coming from said feed circuit.

5. The pressurizer device according to claim 1, further including an exhaust pipe connected to the buffer tank and provided with a regulator device for regulating the pressure in the buffer tank.

6. The rocket engine feed device including a first main tank suitable for containing a first propellant, a first pressurizer device according to claim 1 for pressurizing the first main tank, a second main tank suitable for containing a second propellant, and a second pressurizer device for pressurizing the second main tank, wherein the fuel cell is configured to produce electricity from a reaction between the first propellant and the second propellant.

7. The pressurizing method for pressurizing a main propellant tank, the method comprising:
filling a buffer tank with propellant from the main tank;
using an electric heater powered by a fuel cell to heat the pressurizing fluid situated upstream from a pressurizer valve, the pressurizer valve being arranged in a pressurizer pipe connecting the buffer tank to the main tank, and the fuel cell being fed with propellant by an auxiliary pipe extending between the buffer tank and said fuel cell; and
opening the pressurizer valve to enable the heated propellant to flow to the main tank.

8. The pressuring method according to claim 7, including, before the step of filling the buffer tank, filling the main tank with propellant in the liquid state from an external propellant feed.
